(19) United States
(12) Patent Application Publication
(10) Pub. No.: US 2025/0117460 A1
(43) Pub. Date: Apr. 10, 2025

(54) SYSTEMS AND METHODS FOR DECRYPTING HYPERTEXT MARKUP LANGUAGE (HTML)

(71) Applicant: Capital One Services, LLC, McLean, VA (US)

(72) Inventors: Shahalam BAIG, Rochester, NY (US); Anoop GOPI, Herndon, VA (US); Julian DUQUE, Arlington, VA (US); Daniel E. MILLER, Brooklyn, NY (US)

(73) Assignee: Capital One Services, LLC, McLean, VA (US)

(21) Appl. No.: 18/905,205

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 16/958; G06F 21/60; H04L 67/02

(52) U.S. Cl. CPC G06F 21/107; G06F 16/986; G06F 21/602; H04L 67/02

(57) ABSTRACT

Systems and methods for decrypting a HyperText Markup Language (“HTML”) are described. The method may include obtaining, via a browser module associated with a first user device, an encrypted HTML element; generating, via the browser module associated with the first user device, a first request to decrypt the encrypted HTML element; transmitting, via a processor, the first request and session data; obtaining, via the processor, a license for the encrypted HTML element, wherein the license include a decryption key and at least one rule; determining, via the processor, whether the encrypted HTML element satisfies the at least one rule of the license; upon determining the encrypted HTML element satisfies the at least one rule of the license, decrypting, via the processor, the encrypted HTML element using the decryption key; and causing to output, via a graphical user interface (GUI) associated with the first user device, the decrypted HTML element.

### CROSS-REFERENCE TO RELATED APPLICATION(S)

This application claims the benefit of U.S. Provisional Patent Application No. 63/587,891, filed on Oct. 4, 2023, U.S. Provisional Patent Application No. 63/665,485, filed on Jun. 28, 2024, and U.S. Provisional Patent Application No. 63/683,063, filed on Aug. 14, 2024, all of which are incorporated herein by reference in their entireties.

### TECHNICAL FIELD

Various embodiments of this disclosure relate generally to decrypting HyperText Markup Language (HTML) and, more particularly, to systems and methods for decrypting an HTML element based on a browser session-specific encryption key.

### BACKGROUND

Organizations such as banks and healthcare providers seek to protect sensitive or confidential information (e.g., personally identifiable information (“PII”), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

Social engineering, or techniques aimed at convincing a target (e.g., a user) to reveal specific information or perform a specific action for illegitimate reasons, has become increasingly prevalent in online activities. Conventional methods for protecting the user often rely on the user attempting to confirm the legitimacy of the illegitimate actor, e.g., verbally. These methods fail to account for devious aspects of social engineering, which may erroneously convince a user that they are interacting with a trusted party. Without methods to protect users in such cases, social engineering will continue to result in compromised information.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for decrypting HyperText Markup Language (“HTML”).

In one aspect, a method for decrypting a HyperText Markup Language (HTML) is disclosed. The method may include obtaining, via a browser module associated with a first user device, an encrypted HTML element, generating, via the browser module associated with the first user device, a first request to decrypt the encrypted HTML element, transmitting, via a processor, the first request and session data, obtaining, via the processor, a license for the encrypted HTML element, wherein the license include a decryption key and at least one rule, determining, via the processor, whether the encrypted HTML element satisfies the at least one rule of the license, upon determining the encrypted HTML element satisfies the at least one rule of the license, decrypting, via the processor, the encrypted HTML element using the decryption key, and causing to output, via a graphical user interface (GUI) associated with the first user device, the decrypted HTML element.

In another aspect, a system is disclosed. The system may include at least one memory storing instructions and at least one processor operatively connected to the memory, and configured to execute the instructions to perform operations for decrypting a HyperText Markup Language (HTML). The operations may include detecting, via a browser associated with a first user device, an encrypted HTML element, generating, via the browser associated with a first user device, a first request to decrypt the encrypted HTML element, transmitting, via a processor, the first request and session data, obtaining, via the processor, a license for the encrypted HTML element, wherein the license include a decryption key and at least one rule, determining via the processor, whether the encrypted HTML element satisfies the at least one rule of the license, upon determining the encrypted HTML element satisfies the at least one rule of the license, decrypting, via the processor, the encrypted HTML element using the decryption key, and causing to output, via a graphical user interface (GUI) associated with the first user device, the decrypted HTML element.

In another aspect, a method for decrypting a HyperText Markup Language (HTML) is disclosed. The method may include receiving a request from a first user associated with a first device to access an HTML element, tagging the HTML element, encrypting, via a processor, the tagged HTML element based on at least one rule and session data, wherein the session data includes hardware data associated with a first user device, detecting, via a browser associated with the first user device, the encrypted HTML element, generating, via the processor, a first request to decrypt the encrypted HTML element, transmitting, via the processor, the first request and session data, obtaining, via the processor, a license for the encrypted HTML element, wherein the license include a decryption key and at least one rule, determining, via the processor, whether the encrypted HTML element satisfies the at least one rule of the license, upon determining the encrypted HTML element satisfies the at least one rule of the license, decrypting, via the processor, the encrypted HTML element using the decryption key, and causing to output, via a graphical user interface (GUI) associated with the first user device, the decrypted HTML element.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for decrypting HTML, according to one or more embodiments.

FIGS. 2A-2B depict an exemplary method for decrypting HTML, according to one or more embodiments.

FIG. 3 depicts a simplified functional block diagram of a computer, according to one or more embodiments.

FIGS. 4A-4C depict exemplary schematics for Pixel-Encoded Image Encryption and Leak Detection, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

The phrase “HyperText Markup Language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the phrase “hex code” may refer to a hexadecimal format for identifying colors in an image, on a webpage, etc., and may include color code data, such as color models (Red, Green, Blue (“RGB”) color model; Hue, Saturation, Lightness (“HSL”) color model; Hue, Saturation, Value (“HSV”) color model; Cyan, Magenta, Yellow, and Key (“CMYK”) color model; etc.), Cascading Style Sheets (“CSS”), or HTML color codes.

As used herein, the phrase “media content” may represent a browser, a website, a webpage, etc. As used herein, the phrase “content element” may represent text data, image data, audio data (e.g., a sequence of audio frames), or video data (e.g., a sequence of image frames). A content element may be included in HTML used to structure the website, such as a Document Object Model (“DOM”). In some aspects, the content element may include or represent sensitive or confidential information. As used herein, the phrase “sensitive information” may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

As used herein, the phrase “digital extraction” may refer to any process of copying content (e.g., audio, video, text, image, etc.), such as ripping, screensharing, screenshotting, etc. As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

As used herein, the term “decryption key,” “key,” or the like includes a piece of information, usually a string of numbers or letters that are stored, which, when processed through a cryptographic algorithm, decodes cryptographic data (e.g., decodes an encrypted HTML element).

In an exemplary use case, a first user may wish to screen share with a second user. Conventionally, a user may wish to protect content while screen sharing. However, conventional methods may only be capable of protecting video or multimedia content. The current solution provides a technical advantage in extending protection to other content, such as HyperText Markup Language (HTML) elements. As such, techniques according to the present disclosure enable increased protection and security for users and users' data.

The first user may request display of an encrypted HTML element, e.g., by selecting a “share” option (e.g., via an application such as Zoom®, Microsoft Teams®, etc.) via a graphical user interface (GUI) associated with a first user device. A browser module may request the encrypted HTML element from a data storage, e.g., via a content delivery network (CDN). A CDN may be a group of geographically distributed servers that speed up the delivery of web content by bringing it closer to where users are. The HTML element may be tagged or encrypted, such as by an application server. Upon obtaining the request, the encrypted HTML element may be transmitted from the data storage to the browser module.

The browser module may request a license and session data for the encrypted HTML element. A license server may determine whether the rules of the license are satisfied, e.g., based on the session data for the first user device or a second user device. If the rules of the license are satisfied, the license server may provide a decryption key to the browser module. The browser module may transmit the encrypted HTML element and decryption key to a content decryption module (CDM) for decryption. The CDM may use the key to decrypt the encrypted HTML element, and may transmit the decrypted HTML element to the browser module. The browser module may cause to output the decrypted HTML element via the GUI associated with the first user device, a GUI associated with the second user device, etc.

If the rules of the license are not satisfied, the license server may reject the request for the license. Based on the rejection, the browser module may cause to output a user interface that may include at least one of an alert, a blank screen, a watermark, etc.

While the examples above involve decrypting an HTML element in a screen sharing use case, it should be understood that techniques according to this disclosure may be adapted to any suitable system, method, or configuration. It should also be understood that the examples above are illustrative only. The techniques and technologies of this disclosure may be adapted to any suitable activity. Presented below are various systems and methods of decrypting an HTML element.

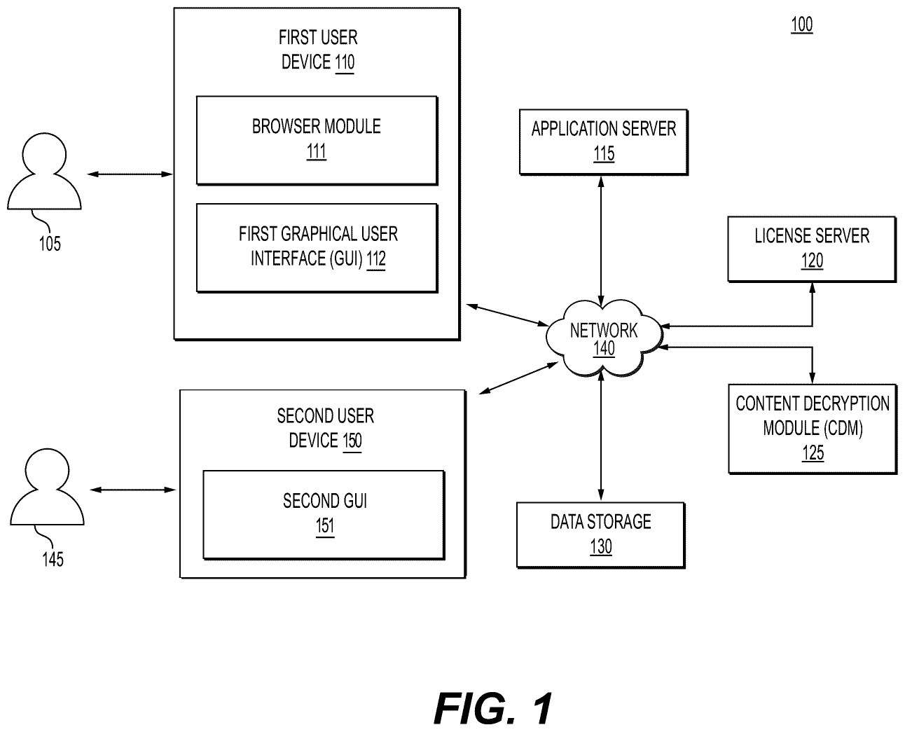

FIG. 1 depicts an exemplary environment 100 for decrypting HyperText Markup Language (“HTML”), according to one or more embodiments. In some aspects, the environment 100 may be an embodiment of (i) environment 100 described in U.S. Provisional Application 63/587,891, filed Oct. 4, 2023 (ii) environment 100 described in U.S. Provisional Application 63/665,485, filed Jun. 28, 2024, or (iii) environment 100 described in U.S. Provisional Application 63/683,063, filed Aug. 14, 2024, where each of these U.S. provisional applications are incorporated by reference herein in their entireties. Environment 100 may include one or more aspects that may communicate with each other over a network 140. In some embodiments, a first user 105 may interact with a first user device 110 such that a request for HTML decryption is generated. As depicted in FIG. 1, first user device 110 may interact with at least one of an application server 115, a license server 120, a Content Decryption Module (CDM) 125, or data storage 130. In some embodiments, as discussed in further detail below, first user device 110 may further interact with a second user device 150.

The first user device 110 may be configured to enable the user to access or interact with other systems in the environment 100. For example, the first user device 110 may be a computer system such as, for example, a desktop computer, a laptop computer, a tablet, a smart cellular phone, a smart watch or other electronic wearable, etc. In some embodiments, the first user device 110 may include one or more electronic applications, e.g., a program, plugin, browser extension, etc., installed on a memory of the first user device 110. In some embodiments, the electronic applications may be associated with one or more of the other components in the environment 100.

First user device 110 may include a browser module 111 or a first graphical user interface (GUI) 112. Browser module 111 may be configured to generate or transmit (e.g., to first GUI 112) an alert or a user interface. Browser module 111 may be an intermediary that is hosted on a website or application responsible for calling or referencing the encrypted content. In some embodiments, the alert (e.g., first alert, second alert, etc.) may include a notice that a second user may be attempting to access the decrypted HTML element. The user interface may include at least one of an alert (e.g., a first alert, a second alert, etc.), a blank screen, a watermark, etc. First user device 110 may obtain data from one or more aspects of environment 100, such as from browser module 111, first GUI 112 (e.g., via one or more inputs from first user 105), application server 115, license server 120, CDM 125, data storage 130, second user device 150, second GUI 151 (e.g., via one or more inputs from second user 145), etc. First user device 110 may transmit data to one or more aspects of environment 100, e.g., to browser module 111, first GUI 112, application server 115, license server 120, CDM 125, data storage 130, second user device 150, second GUI 151, etc.

In some embodiments, a second user 145 may interact with second user device 150. For example, second user 145 may interact with second user device 150 via a second GUI 151. As depicted in FIG. 1, second user device 150 may interact with at least one of first user device 110, browser module 111, first GUI 112, application server 115, license server 120, Content Decryption Module (CDM) 125, data storage 130, second GUI 151, etc.

Second user device 150 may be configured to enable second user 145 to access or interact with other systems in the environment 100. For example, second user device 150 may be a computer system such as, for example, a desktop computer, a laptop computer, a tablet, a smart cellular phone, a smart watch or other electronic wearable, etc. In some embodiments, second user device 150 may include one or more electronic applications, e.g., a program, plugin, browser extension, etc., installed on a memory of second user device 150. In some embodiments, the electronic applications may be associated with one or more of the other components in the environment 100.

Second user device 150 may obtain data from one or more aspects of environment 100, such as from first user device 110, browser module 111, first GUI 112 (e.g., via one or more inputs from first user 105), application server 115, license server 120, CDM 125, data storage 130, second GUI 151 (e.g., via one or more inputs from second user 145), etc. Second user device 150 may transmit data to one or more aspects of environment 100, e.g., to first user device 110, browser module 111, first GUI 112, application server 115, license server 120, CDM 125, data storage 130, second GUI 151, etc.

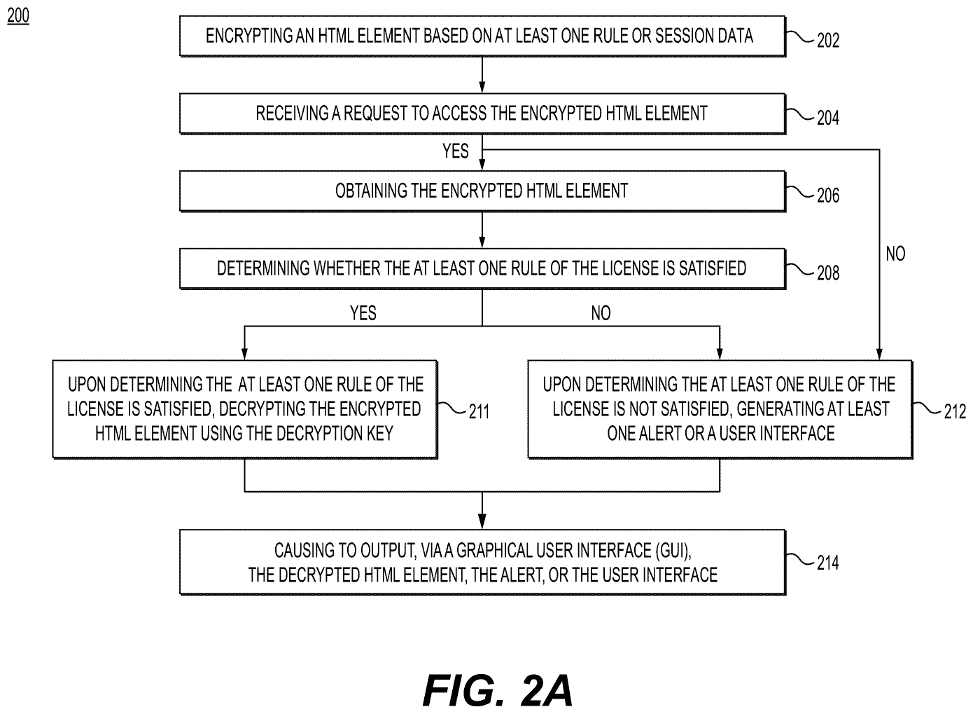

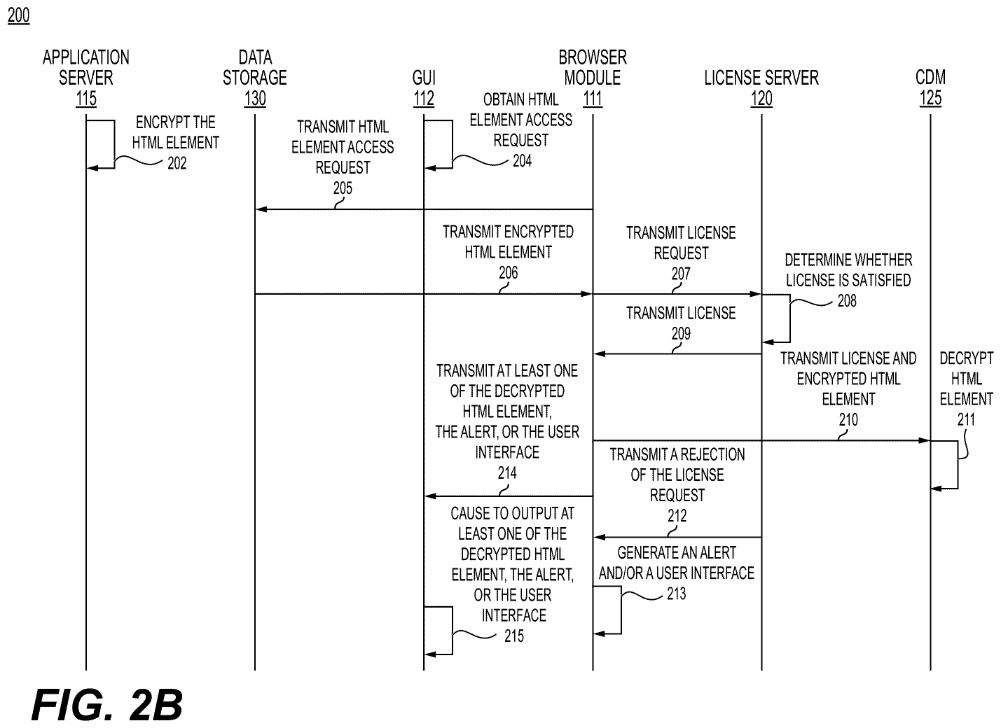

Application server 115 may be configured to tag or encrypt the contents of the HTML element. The HTML element may be tagged or referenced through at least one unique identifier. The at least one unique identifier is processed through application server 115, or through a set of libraries that may encrypt the HTML element. Tagging the HTML element may subsequently trigger the outputting of a decrypted HTML element, an alert, or a user interface (see step 214 of FIG. 2A) for authorized or unauthorized users. Tagging or encrypting the HTML element may be device-specific. Application server 115 may obtain data from one or more aspects of environment 100, e.g., from first user device 110, browser module 111, first GUI 112 (e.g., via one or more inputs from first user 105), license server 120, CDM 125, data storage 130, second user device 150, second GUI 151 (e.g., via one or more inputs from second user 145), etc. Application server 115 may transmit data from one or more aspects of environment 100, e.g., to first user device 110, browser module 111, first GUI 112, license server 120, CDM 125, data storage 130, second user device 150, second GUI 151, etc.

License server 120 may be configured to determine whether a request for decryption of an encrypted HTML element satisfies session data or a license. Whether the request satisfies the license may be determined based on a comparison of the request for decryption or the session data to the rules of the license (e.g., based on a rules-based manifest). The session data may include hardware data associated with a user device, e.g., first user device 110, browser session data, internet protocol (IP) address, media access control (MAC) address, device operating system (OS), version number, browser version, country, preferred location, client correlation identification, etc. The license may be a binary executable (e.g., a blob) including at least one rule or a decryption key. The at least one rule may be set by a user, e.g., first user 105. Any suitable rule or combination of rules may be used. For example, the at least one rule may be that a particular device associated with a user is used to access the HTML element. In some embodiments, the decryption key may be session-specific.

License server 120 may obtain data from one or more aspects of environment 100, e.g., from first user device 110, browser module 111, first GUI 112 (e.g., via one or more inputs from first user 105), application server 115, CDM 125, data storage 130, second user device 150, second GUI 151 (e.g., via one or more inputs from second user 145), etc. License server 120 may transmit data from one or more aspects of environment 100, e.g., to first user device 110, browser module 111, first GUI 112, application server 115, CDM 125, data storage 130, second user device 150, second GUI 151, etc.

CDM 125 may be configured to decrypt the HTML element, e.g., based on the encryption key. CDM 125 may be configured to decrypt the HTML element based on a pre-determined algorithm that encrypts and decrypts packets of data at a cadence, process, and method unique to the application. CDM 125 may obtain data from one or more aspects of environment 100, e.g., from first user device 110, browser module 111, first GUI 112 (e.g., via one or more inputs from first user 105), application server 115, license server 120, data storage 130, second user device 150, second GUI 151 (e.g., via one or more inputs from second user 145), etc. CDM 125 may transmit data from one or more aspects of environment 100, e.g., to first user device 110, browser module 111, first GUI 112, application server 115, license server 120, CDM 125, data storage 130, second user device 150, second GUI 151, etc.

Data storage 130 may be configured to store encrypted HTML elements, the license, session data, etc. Data storage 130 may be configured to retrieve the encrypted HTML element based on the tag applied to the encrypted HTML element. Data storage 130 may be configured to retrieve a license via a number of methods that are session-specific or entity- or organization-specific. Data storage 130 may be configured to retrieve session data based on the user, e.g., based on a user identification, etc.

Data storage 130 may be configured to obtain data from one or more aspects of environment 100, e.g., from first user device 110, browser module 111, first GUI 112 (e.g., via one or more inputs from first user 105), application server 115, license server 120, CDM 125, data storage 130, second user device 150, second GUI 151 (e.g., via one or more inputs from second user 145), etc. Data storage 130 may be configured to transmit data to one or more aspects of environment 100, e.g., to first user device 110, browser module 111, first GUI 112, application server 115, license server 120, CDM 125, data storage 130, second user device 150, second GUI 151, etc.

One or more of the components in FIG. 1 may communicate with each other or other systems, e.g., across network 140. In some embodiments, network 140 may connect one or more components of environment 100 via a wired connection, e.g., a USB connection between first user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often—abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, application server 115 may be integrated in license server 120. In another example, first user device 110 may further include application server 115. In some embodiments, operations or aspects of one or more of the components discussed above may be distributed amongst one or more other components. In some embodiments, some of the components of environment 100 may be associated with a common entity, while others may be associated with a disparate entity. For example, application server 115, license server 120, or CDM 125 may be associated with a common entity (e.g., an entity with which first user 105 has an account) while data storage may be associated with a third party (e.g., a provider of data storage services). Any suitable arrangement or integration of the various systems and devices of the environment 100 may be used.

FIGS. 2A and 2B depict an exemplary method 200 for decrypting HyperText Markup Language (HTML), according to one or more embodiments. At step 202, an HTML element may be encrypted based on at least one rule or session data. In some techniques, application server 115 may encrypt the HTML element by making a request to license server 120 with the rules for displaying that HTML element and session data. In some techniques, the HTML element may be tagged prior to encryption. The tag may include a specific tag or Cascading Style Sheets (CSS). The tag may refer to an HTML element that may need to be encrypted. HTML elements targeted for encryption may include any that contain sensitive information or information that needs to be secured (e.g., card verification value (CVV), Social Security Number, credit card numbers, etc.). Standard encryption methods may be utilized. Encryption methods may be changed or modified depending on the level of security needed for the end data. The encrypted HTML element may be transferred to browser module 111.

At step 204, a request (e.g., a first request, a second request, etc.) to access the encrypted HTML element may be obtained, e.g., by browser module 111. In some techniques, a first request may be associated with a first user (e.g., first user 105) and a second request may be associated with a second user (e.g., second user 145). For example, first user 105 may request to access the encrypted HTML element via first GUI 112. In some techniques, a request to access the encrypted HTML element may be obtained from second user 145, e.g., via second GUI 151. For example, second user 145 may request to access the encrypted HTML element via second GUI 151. Upon determining second user 145 is requesting to access the encrypted HTML element, a permission request may be generated or output (e.g., to first GUI 112 of first user device 110 associated with the first user). If the permission request is approved by first user 105, method 200 may continue to step 205-214 (see FIG. 2B for steps 205, 207, 209, and 211). If the permission request is rejected by first user 105, method 200 may proceed to steps 212-214.

At step 205, the request to access the encrypted HTML element may be transmitted, e.g., from browser module 111 to data storage 130. At step 206, the encrypted HTML element may be transmitted from data storage 130 and obtained by browser module 111.

At step 207, a license request may be transmitted, e.g., from browser module 111 to license server 120. The license request may include a request to determine whether the at least one rule of the license is satisfied. At step 208, whether the at least one rule of the license is satisfied is determined. The data in the request (e.g., known user, device identification, location, etc.) may be used to confirm the license.

At step 209, upon determining the at least one rule of the license is satisfied, the license may be transmitted, e.g., from license server 120 to browser module 111. As discussed above, a decryption key may be included in the license. At step 210, the license and encrypted HTML element may be transmitted, e.g., to CDM 125. At step 211, the encrypted HTML element may be decrypted, e.g., using the decryption key.

At step 212, upon determining the at least one rule of the license is not satisfied, a rejection of the license request may be transmitted from license server 120 to browser module 111. At step 213, upon obtaining the rejection of the license request, at least one of an alert (e.g., a first alert, a second alert, etc.) or a user interface may be generated, e.g., via browser module 111. For example, the alert (e.g., a first alert) may include the determination that the at least one rule of the license is not satisfied. In another example, the alert (e.g., the first alert) may include a notice that the second user is attempting to access the decrypted HTML element. In a further example, the alert (e.g., a second alert) may include a rejection of the request to decrypt the encrypted HTML element. As discussed herein, the user interface may be generated to include at least one of the alert (e.g., the first alert, the second alert, etc.), a blank screen, or a watermark, a lack of content rending, disabled of features, grayed out content areas, warning messages, alternate data/information, etc.

At step 214, at least one of the decrypted HTML element, the alert, or the user interface may be transmitted, e.g., from browser module 111 to first GUI 112. At step 215, at least one of the decrypted HTML element, the alert, or the user interface may be caused to be output, e.g., via first GUI 112. For example, the first alert may be caused to be output via first GUI 112. In another example, the second alert may be caused to be output via second GUI 151. In a further example, the user interface may be caused to be output via one or both of first GUI 112 or second GUI 151.

The techniques described herein may be applied to myriad applications, such as content obfuscation, pixel-encoded image encryption and leak detection, DRM-protected HTML, or DRM-based screen share and screenshot detection. Each of these exemplary embodiments, and the application of the techniques discussed above, are described below.

### Content Obfuscation

In some embodiments, the techniques discussed above may be applied to content obfuscation (e.g., utilizing the DRM techniques described above to dynamically block sensitive information from view of a social engineer). Sensitive or protected information may be protected from being captured through digital extraction (e.g., screenshots, screen shares, etc.) via the techniques described herein. For example, in some techniques, the need to obfuscate content on webpages may be achieved by introducing an intermediary application that aggregates at least one digital rights management (“DRM”) platform, and utilizes the hardware-based encryption and decryption utilities of the at least one DRM platform to block screenshots or screen shares of specific content, e.g., on webpages.

Conventionally, the at least one DRM platform may be developed, managed, or maintained by large hardware and software manufacturers, who have access to internal device systems to ensure that content may be blocked. The techniques described herein (e.g., method 200), which may exist as a library, entity on a website, application (e.g., application downloaded to a user device, such as a computer or cell phone), or browser extension, utilizes a unique method that may involve displaying sensitive information behind a transparent video, or image, thereby engaging DRM protections that may prevent capture.

Content obfuscation may include an intermediary application that may be utilized by websites or other digital platforms where sensitive content or information is displayed. When a user (e.g., first user 105) attempts to view sensitive information (e.g., while digital extraction may be occurring), the application may utilize a DRM-protected video or image to overlay on top of the content, effectively blocking screenshots and screen shares. The protected video or image may trigger DRM protections in devices, preventing the data from being screenshotted or shared across a wide range of devices. Additionally, a user (e.g., first user 105) may be able to select to include a transparent DRM-protected image or video that exists continually on top of sensitive content to block capture without the use of screenshot detection.

The mechanisms in DRM that detect screenshots may be utilized to stop screenshot attempts in real-time. Once detected, the device may interface with the respective DRM, based on the hardware of the device, ensuring that the protected information cannot be captured. As such, the techniques described herein introduce a novel approach to safeguarding various types of content, beyond videos.

### Pixel-Encoded Image Encryption and Leak Detection

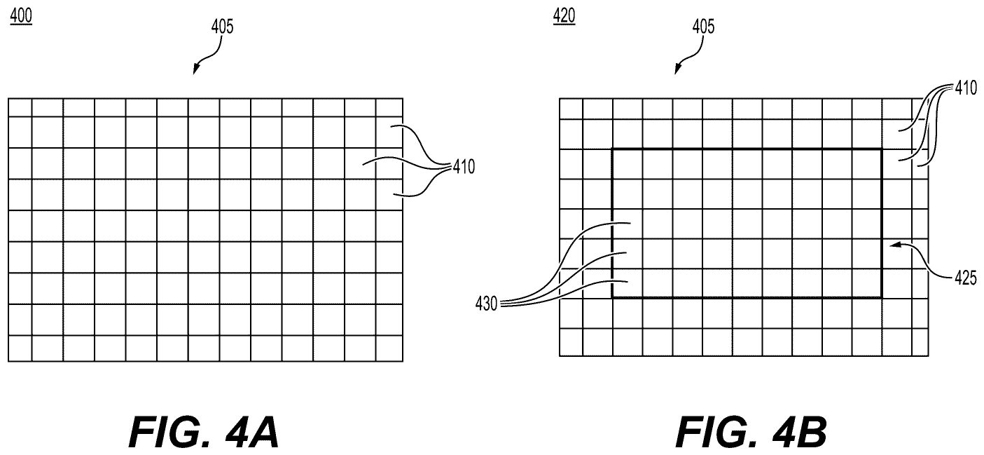

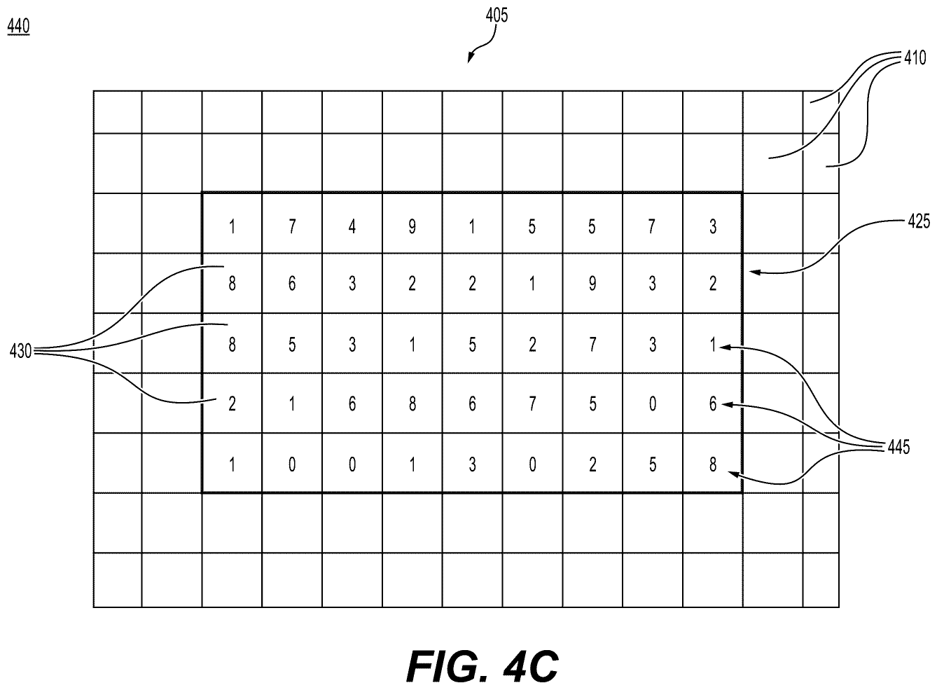

In some embodiments, the techniques discussed above may be applied to pixel-encoded image encryption and leak detection (e.g., by utilizing the DRM techniques described above to dynamically encrypt media at pixel-level to protect the media from being stolen or to prevent unauthorized access of the media). As discussed in further detail in FIGS. 4A-4C, for pixel-encoded image encryption and leak detection, a section of an image 405 may be altered or encoded. As depicted in schematic 400 of FIG. 4A, image 405 may include a plurality of pixels 410. A subset of the plurality of pixels 410 may be altered or encoded to generate an encoded area 425, as depicted in schematic 420 of FIG. 4B. The plurality of altered or encoded pixels will be referred hereafter to as encoded pixels 430.

Each of the encoded pixels 430 may include a unique identifier 445, which may be decrypted via a hex code on encoded pixels 430. Additional image data and parameters may be used to assist with the encryption of the encoded pixels 430. Encoded pixels 430 may be randomized throughout image 405 and may not be clustered in order to fall under detection, or encoded pixels 430 may be clustered as depicted in schematic 440 of FIG. 4C. Pixel-encoded image encryption and leak detection may be used in conjunction with DRM technology, thereby it may only appear during digital extraction, e.g., on screenshots or screen shares.

Pixel-encoded image encryption and leak detection may be configured to encrypt images, detect leaks, or authenticate an image. For example, if an image is altered, changes in the pixel encoding may enable detection of any changes. The entire image may be encoded and the engine may detect alteration from the original source image.

### DRM-Protected HTML

In some embodiments, the techniques discussed above may be applied to DRM-protected HTML (e.g., by utilizing the DRM techniques described above to encrypt HTML to prevent unauthorized access of HTML-based sensitive information). An HTML page containing sensitive elements (e.g., text or images) may embed a tag (e.g., a video HTML5<video>tag, etc.) with a dynamic Uniform Resource Locator (“URL”) on an internal server. The server may composite the information to be displayed into a static 2D buffer, and may encode and encrypt the buffer with a web video following a DRM model, coding it as a single frame-looping video. The video may be a static image derived from the sensitive content. For example, the single frame-looped video may be a static image that is representative of the sensitive content. The browser may decrypt and may display the “video” (e.g., the 2D static buffer) using video DRM technology that may be built into the browser, operating system, display, etc. The user's computer (e.g., first user device 110) may not need to install anything or do anything different. From the user's perspective, the entity hosting the browser may have a number of embedded videos on the webpage. The “video” may utilize hardware based security methods built into a DRM platform to block digital extraction (e.g., screenshots or screen shares) of the content.

### DRM-Based Screen Share and Screenshot Detection

In some embodiments, the techniques discussed above may be applied to DRM-based screen share and screenshot detection (e.g., by utilizing the DRM techniques described above to dynamically detect indirect measures of digital extraction to dynamically predict when digital extraction may be occurring or may have occurred). A website or web application may contain DRM artifacts that may enable the website or web application to detect whether digital extraction (e.g., a screenshot or screen share) may be happening on the end user's screen (e.g., on first GUI 112). Detection may be accomplished by utilizing a DRM protocol to detect hardware-based encryption disruptions, which may result in a screenshot being detected. The artifact may be hidden from the user interface, or may be displayed as a stream on the page. The application may track whether there is a disruption in the host licensing for the DRM artifact for this detection. If a screenshot or share is detected, the website may display large areas of DRM-protected streamed video or image content, effectively blocking sensitive content from being shared, streamed, or casted.

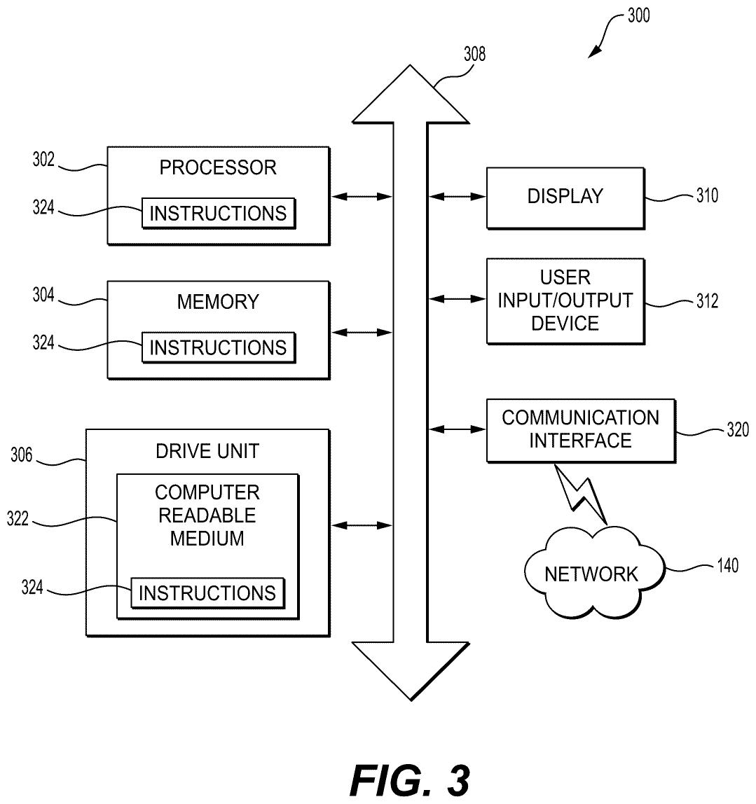

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for decrypting a HyperText Markup Language (HTML), the method comprising:
obtaining, via a browser module associated with a first user device, an encrypted HTML element;
generating, via the browser module associated with the first user device, a first request to decrypt the encrypted HTML element;
transmitting, via a processor, the first request and session data;
obtaining, via the processor, a license for the encrypted HTML element, wherein the license include a decryption key and at least one rule;
determining, via the processor, whether the encrypted HTML element satisfies the at least one rule of the license;
upon determining the encrypted HTML element satisfies the at least one rule of the license, decrypting, via the processor, the encrypted HTML element using the decryption key; and
causing to output, via a graphical user interface (GUI) associated with the first user device, the decrypted HTML element.

2. The method of claim 1, wherein the session data includes hardware data associated with the first user device.

3. The method of claim 1, further comprising:
tagging the HTML element; and
encrypting, via the processor, the tagged HTML element based on the at least one rule and the session data to generate the encrypted HTML element.

4. The method of claim 3, wherein tagging the HTML element includes adding one or both of an HTML tag or Cascading Style Sheets (CSS).

5. The method of claim 1, further comprising:
upon determining the encrypted HTML element does not satisfy the at least one rule of the license, generating a first alert to first user; and
causing to output, via the GUI associated with the first user device, the first alert.

6. The method of claim 5, wherein the first alert includes a notice that a second user is attempting to access the decrypted HTML element.

7. The method of claim 1, further comprising:
obtaining a second request from a second user associated with a second user device to decrypt the encrypted HTML element;
obtaining permission from a first user associated with the first user device to decrypt the encrypted HTML element based on the second request; and
upon obtaining permission from the first user, detecting the encrypted HTML element.

8. The method of claim 7, further comprising:
upon determining the encrypted HTML element does not satisfy the at least one rule of the license, generating a second alert to the second user; and
causing to output, via a GUI associated with the second user device, the second alert.

9. The method of claim 8, wherein the second alert includes a rejection of the second request to decrypt the encrypted HTML element.

10. The method of claim 8, further comprising:
upon determining the encrypted HTML element does not satisfy the at least one rule of the license, generating a user interface, wherein the user interface include one or more of the second alert, a blank screen, or a watermark; and
causing to output, via the GUI associated with the first user device, the user interface.

11. A system, the system comprising:
at least one memory storing instructions; and
at least one processor operatively connected to the memory, and configured to execute the instructions to perform operations for decrypting a HyperText Markup Language (HTML), the operations including:
detecting, via a browser associated with a first user device, an encrypted HTML element;
generating, via the browser associated with a first user device, a first request to decrypt the encrypted HTML element;
transmitting, via a processor, the first request and session data;
obtaining, via the processor, a license for the encrypted HTML element, wherein the license include a decryption key and at least one rule;
determining via the processor, whether the encrypted HTML element satisfies the at least one rule of the license;
upon determining the encrypted HTML element satisfies the at least one rule of the license, decrypting, via the processor, the encrypted HTML element using the decryption key; and
causing to output, via a graphical user interface (GUI) associated with the first user device, the decrypted HTML element.

12. The system of claim 11, wherein the session data includes hardware data associated with the first user device.

13. The system of claim 11, the operations further comprising:
tagging the HTML element; and
encrypting, via the processor, the tagged HTML element based on the at least one rule and the session data to generate the encrypted HTML element.

14. The system of claim 11, the operations further comprising:
upon determining the encrypted HTML element does not satisfy the at least one rule of the license, generating a first alert to first user; and
causing to output, via a GUI associated with the first user device, the first alert.

15. The system of claim 14, wherein the first alert includes a notice that a second user is attempting to access the decrypted HTML element.

16. The system of claim 11, the operations further comprising:
obtaining a second request from a second user associated with a second user device to decrypt the encrypted HTML element;
obtaining permission from a first user associated with the first user device to decrypt the encrypted HTML element based on the second request; and
upon obtaining permission from the first user, detecting the encrypted HTML element.

17. The system of claim 16, the operations further comprising:
upon determining the encrypted HTML element does not satisfy the at least one rule of the license, generating a second alert to the second user; and
causing to output, via a GUI associated with the second user device, the second alert.

18. The system of claim 17, wherein the second alert includes a rejection of the second request to decrypt the encrypted HTML element.

19. The system of claim 17, the operations further comprising:
upon determining the encrypted HTML element does not satisfy the at least one rule of the license, generating a user interface, wherein the user interface include one or more of the second alert, a blank screen, or a watermark; and
causing to output, via the GUI associated with the first user device, the user interface.

20. A method for decrypting a HyperText Markup Language (HTML), the method comprising:
receiving a request from a first user associated with a first device to access an HTML element;
tagging the HTML element;
encrypting, via a processor, the tagged HTML element based on at least one rule and session data, wherein the session data includes hardware data associated with a first user device;
detecting, via a browser associated with the first user device, the encrypted HTML element;
generating, via the processor, a first request to decrypt the encrypted HTML element;
transmitting, via the processor, the first request and session data;
obtaining, via the processor, a license for the encrypted HTML element, wherein the license include a decryption key and at least one rule;
determining, via the processor, whether the encrypted HTML element satisfies the at least one rule of the license;
upon determining the encrypted HTML element satisfies the at least one rule of the license, decrypting, via the processor, the encrypted HTML element using the decryption key; and
causing to output, via a graphical user interface (GUI) associated with the first user device, the decrypted HTML element.
